(19) United States
(12) Patent Application Publication
(10) Pub. No.: US 2021/0213560 A1
(43) Pub. Date: Jul. 15, 2021

(54) DEVICE ACHIEVING FASTENING OF PARTS BY HIGH-FREQUENCY VIBRATION

(71) Applicant: HONG FU JIN PRECISION INDUSTRY (WuHan) CO., LTD., Wuhan (CN)

(72) Inventor: YU-HSU LIN, Santa Clara, CA (US)

(21) Appl. No.: 16/928,281

(22) Filed: Jul. 14, 2020

Related U.S. Application Data
(63) Continuation-in-part of application No. PCT/CN2020/071210, filed on Jan. 9, 2020.

(51) Int. Cl. B23K 20/10

(52) U.S. Cl. CPC B23K 20/10; B23K 2103/04

(57) ABSTRACT

A device for fastening a first assembly into a second assembly by applying high-speed vibration includes a location detection unit and an adsorption unit. The location detection unit records locations of the first assembly and the second assembly. The adsorption unit adsorbs the first assembly and adjusts the first assembly by vibration according to the locations of the first assembly and the second assembly to achieve a fastening of the first assembly into the second assembly.

### FIELD

The subject matter herein generally relates to fasteners and assembly devices.

### BACKGROUND

For the manual fastening process of male and female connectors, the female connector usually has chamfers. When there is a slight deviation in the fastening, a human can adjust a direction, a timing, and a pressing force by feel, so that the two connectors are fastened together.

However, when an automatic fastening device is used for male and female fastening, three cameras are needed to accurately locate the spatial positioning, which is costly and time-consuming.

Therefore, there is room for improvement within the art.

### BRIEF DESCRIPTION OF THE DRAWINGS

Many aspects of the disclosure can be better understood with reference to the figures. The components in the figures are not necessarily drawn to scale, the emphasis instead being placed upon clearly illustrating the principles of the disclosure.

FIG. 1 is an isometric view of a fastening device according to an embodiment of the present disclosure.

FIG. 2 is a block diagram of the fastening device of FIG. 1.

FIG. 3 is an isometric view of a trajectory of a flexible board of the fastening device of FIG. 1.

FIG. 4A to FIG. 4D are isometric views showing a first assembly fully fastened to a second assembly by adjusting locations of the fastening device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

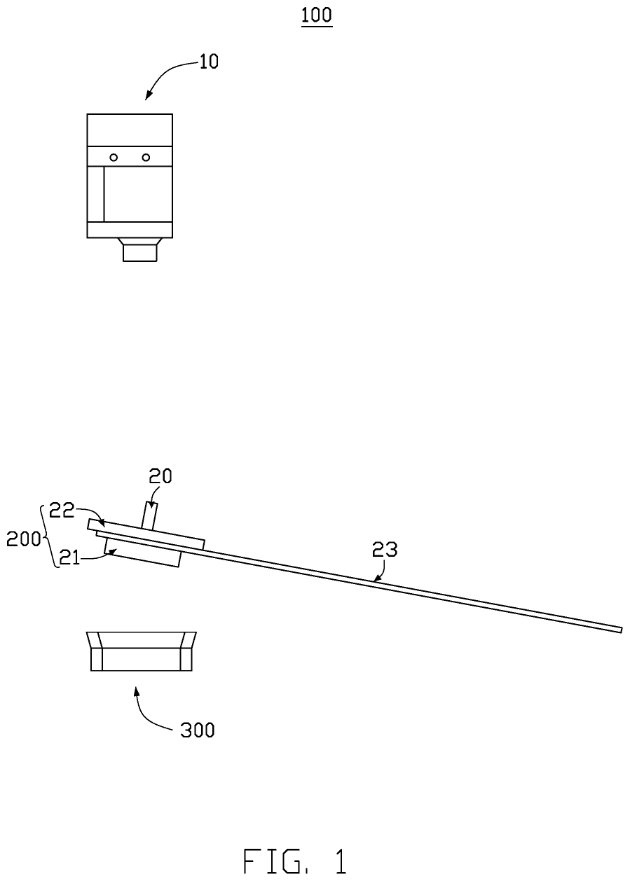

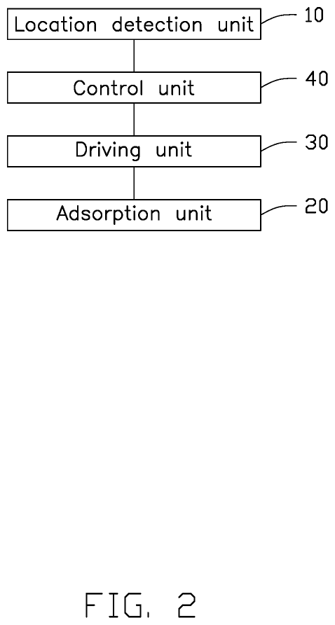

FIG. 1 illustrates a fastening device 100. The fastening device 100 allows automatic fastening of a first assembly 200 into a second assembly 300. As illustrated in FIG. 2, the fastening device 100 includes a location detection unit 10, an adsorption unit 20, a driving unit 30, and a control unit 40. The location detection unit 10 and the driving unit 30 are both electrically connected to the control unit 40. The adsorption unit 20 is electrically connected to the driving unit 30. The adsorption unit 20 is configured to adsorb the first assembly 200 so as to fasten the first assembly 200 into the second assembly 300.

In this embodiment, the location detection unit 10 is a camera. The location detection unit 10 is positioned above the second assembly 300. The location detection unit 10 is electrically connected to the control unit 40. The location detection unit 10 records a location of the first assembly 200 and sends a first location signal to the control unit 40. The location detection unit 10 also records a location of the second assembly 300 and sends a second location signal to the control unit 40.

In one embodiment, the adsorption unit 20 is a vacuum suction nozzle. The adsorption unit 20 is electrically connected to and driven by the driving unit 30 to adsorb the first assembly 200. In one embodiment, the driving unit 30 may be a robot. The control unit 40 is a host.

In this embodiment, the first assembly 200 includes a first element 21, a metal sheet 22, and a flexible board 23.

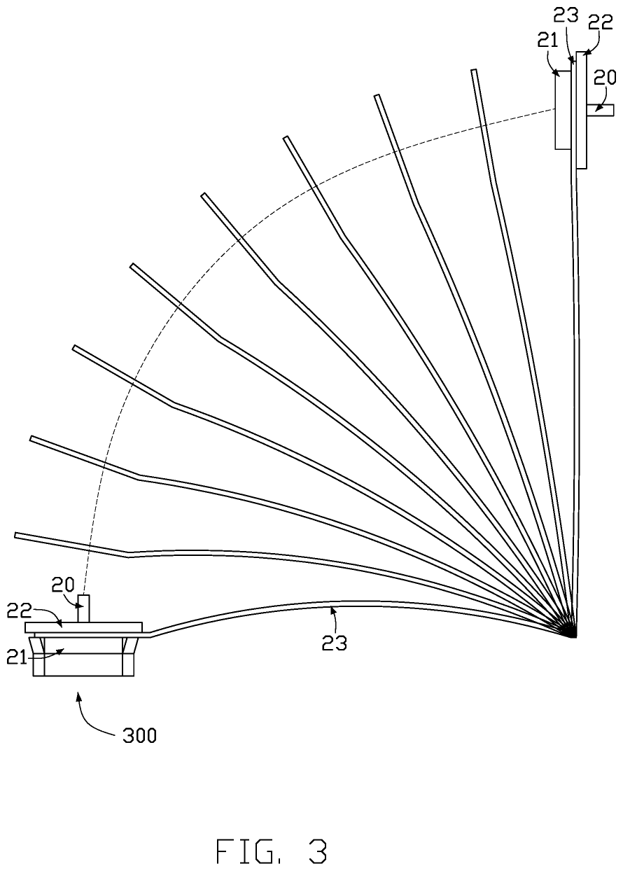

As illustrated in FIG. 3, one end of the flexible board 23 is fixed. The metal sheet 22 is fixed on a first surface of the other end of the flexible board 23 and is positioned away from the second assembly 300. The metal sheet 22 is configured to be adsorbed by the adsorption unit 20. In this embodiment, the metal sheet 22 may be a sheet of steel or other material that can be adsorbed by the adsorption unit 20.

In this embodiment, the first element 21 is a connector. The second assembly 300 is also a connector. The first element 21 is fixed on a second surface of the flexible board 23 away from the metal sheet 22 and faces to the second assembly 300. In this way, the first element 21 can be fastened into the second assembly 300. In this embodiment, the second surface is opposite to the first surface.

In this embodiment, the flexible board 23 is made of a flexible material and thus can be bent. When the adsorption unit 20 adsorbs the metal sheet 22 to drive the first assembly 200 to move, the flexible board 23 maintains a circular arc with a decreasing radius to achieve minimum stress. Furthermore, since one end of the flexible board 23 is fixed, the first assembly 200 will form a fixed movement trajectory during any movement.

In this embodiment, when using the fastening device 100, the location detection unit 10 firstly photographs a location of the second assembly 300 and sends a first location signal to the control unit 40. The control unit 40 controls the driving unit 30 to drive the adsorption unit 20 to adsorb the first assembly 200. The first assembly 200 is adsorbed so as to approach the second assembly 300 along a certain trajectory.

When the first assembly 200 moves to a monitoring area of the location detection unit 10, the location detection unit 10 photographs a location of the first element 21 and sends a second location signal to the control unit 40. The control unit 40 determines whether the first assembly 200 corresponds to the second assembly 300 according to the first location signal and the second location signal. When the control unit 40 determines that the first element 21 of the first assembly 200 is completely aligned with the second assembly 300 according to the first location signal and the second location signal, the adsorption unit 20 is driven to adsorb the first assembly 200, and the first element 21 of the first assembly 200 is fully fastened into the second assembly 300. That is, an automatic fastening is achieved.

As long as the control unit 40 determines that the first element 21 of the first assembly 200 is not completely aligned with the second assembly 300 according to the first location signal and the second location signal, the control unit 40 controls the driving unit 30 and the adsorption unit 20 to push downward. Then, the adsorption unit 20 absorbs and discharges the first element 21 at a high frequency to generate a sequence of very rapid but very small movements (fastener chatter). Such fastener chatter causes the first element 21 to gradually slide into the second assembly 300 and finally, the automatic fastening is achieved.

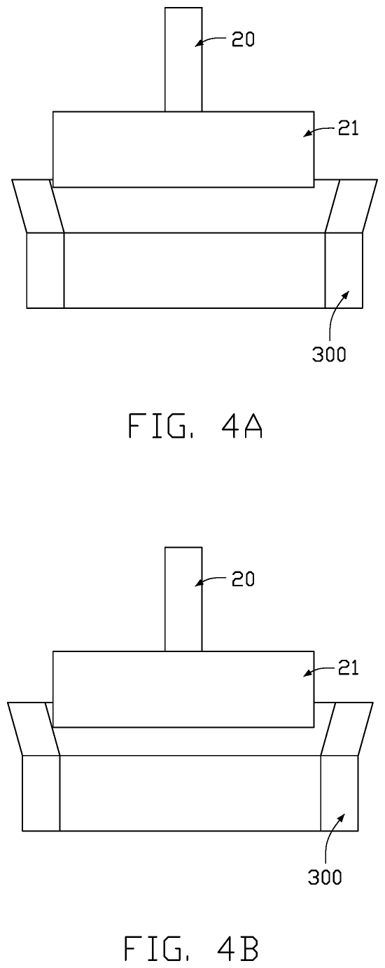

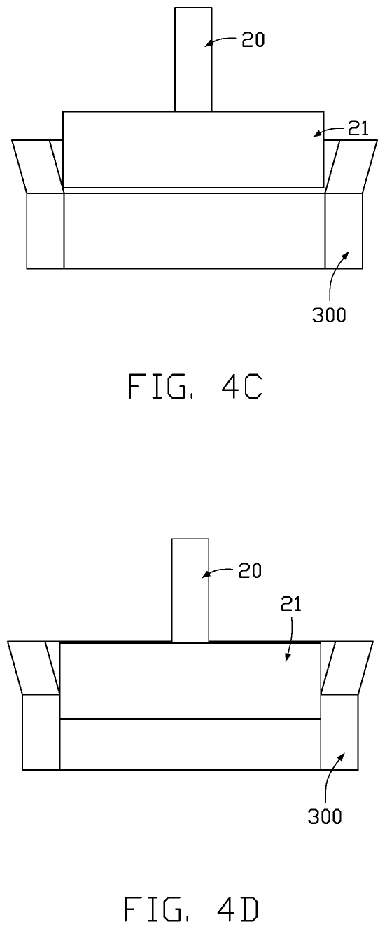

For example, as illustrated in FIG. 4A to FIG. 4D, a fastening process shows the first assembly 200 fully fastened to the second assembly 300 by adjusting locations of the first assembly 200. FIG. 4A to FIG. 4C show the first assembly 200 sliding along a surface of a chamfer of the second assembly 300. FIG. 4D shows the first assembly 200 sliding into the second assembly 300, where the first assembly 200 becomes fully fastened into and electrically connected to the second assembly 300.

In this embodiment, during the fastening process, when the location detection unit 10 determines that the first location signal of the first element 21 and the second location signal are inconsistent in terms of alignment, there is an error in the first assembly 200 fastening to the second assembly 300 the first time or the first attempt. In this way, a length of the flexible board 23 can be dynamically adjusted by the driving unit 30 by driving the adsorption unit 20 to adsorb and release multiple times at high frequency. A location of the first element 21 can be adjusted until the control unit 40 receives a first location signal which is the same as the second location signal, which indicates that the first assembly 200 is fastenable or is fastened to the second assembly 300.

Specifically, when an error is apparent in the fastening process, as illustrated in FIG. 4A, the driving unit 30 drives the adsorption unit 20, along the movement trajectory, to adsorb the first assembly 200 for correct fastening into the second assembly 300 for immediate or first time fastening. Next, as illustrated in FIG. 4B, the first assembly 200 is pushed by the adsorption unit 20 to fasten the first element 21 into the second assembly 300. At this time, the first element 21 only resists a chamfer of the second assembly 300 and thus is not fully fastened into the second assembly 300. Then the control unit 40 determines that the second location signal is inconsistent with the first location signal. The control unit 40 sends a control signal to the driving unit 30. Then, as illustrated in FIG. 4C, according to the control signal, the driving unit 30 re-drives the adsorption unit 20, and a fastener chatter is generated by the high-frequency suction and discharge. The fastener chatter causes the first element 21 to gradually slide into the second assembly 300 along with the chamfer of the second assembly 300. Finally, as illustrated in FIG. 4D, when the control unit 40 determines that the first location signal is the same as the second location signal, the automatic fastening is completed. That is, the first assembly 200 and the second assembly 300 are fully fastened and are connected electrically with each other.

In other embodiments, the adsorption unit 20 is not limited to being a vacuum suction nozzle. The adsorption unit 20 may also be a magnet or other components used to adjust the location of the first assembly 200. For example, the adsorption unit 20 may also be a vibrating pillar. When there is an error in the fastening process of the first assembly 200 and the second assembly 300, the pillar can continuously push the first assembly 200 by a chattering motion, so that the first element 21 gradually slides into the second assembly 300. Finally, the first assembly 200 and the second assembly 300 are automatically fastened.

The fastening device 100 of the present disclosure records the locations of the first assembly 200 and the second assembly 300 through the location detection unit 10, and automatically and dynamically adjusts the locations of the first assembly 200 and the second assembly 300, so as to achieve automatic fastening, while reducing a cost of the device and improving production efficiency.

It is believed that the embodiments and their advantages will be understood from the foregoing description, and it will be apparent that various changes may be made thereto without departing from the scope of the disclosure or sacrificing all of its advantages, the examples hereinbefore described merely being illustrative embodiments of the disclosure.

What is claimed is:

1. A fastening device for fastening a first assembly into a second assembly, the fastening device comprising:
a location detection unit positioned above the second assembly, the location detection unit recording locations of the first assembly and the second assembly; and
an adsorption unit configured to adsorb the first assembly;
wherein the adsorption unit further adjusts the first assembly by vibration according to the locations of the first assembly and the second assembly to achieve a fastening of the first assembly into the second assembly.

2. The fastening device of claim 1, further comprising a control unit, wherein the control unit is electrically connected to the location detection unit, the location detection unit records a location of the first assembly and sends a first location signal to the control unit, the location detection unit also records a location of the second assembly and sends a second location signal to the control unit, the control unit determines whether the first assembly is fastened into the second assembly by the first and second location signals.

3. The fastening device of claim 2, further comprising a driving unit, wherein the driving unit is electrically connected to the control unit and the adsorption unit, the driving unit is configured to drive the adsorption unit to adsorb the first assembly under a control of the control unit.

4. The fastening device of claim 3, wherein when the control unit determines that the first assembly is completely aligned with the second assembly according to the first location signal and the second location signal, the adsorption unit is driven to adsorb the first assembly, and the first assembly is fully fastened into the second assembly; and
when the control unit determines that the first assembly is not completely aligned with the second assembly according to the first location signal and the second location signal, the control unit controls the driving unit and the adsorption unit to push downward, the adsorption unit absorbs and discharges the first assembly at a high frequency to generate a fastener chatter, the fastener chatter causes the first assembly to gradually slide into the second assembly.

5. The fastening device of claim 1, wherein the location detection unit is a camera.

6. The fastening device of claim 1, wherein the adsorption unit is a vacuum suction nozzle.

7. The fastening device of claim 3, wherein the control unit is a host and the driving unit is a robot.

8. A fastening device for fastening a first assembly into a second assembly, the first assembly comprising a first element, the fastening device comprising:
a location detection unit positioned above the second assembly, the location detection unit recording locations of the first element and the second assembly; and
an adsorption unit configured to adsorb the first assembly;
wherein the adsorption unit further adjusts the first assembly according to the locations of the first element and the second assembly to fasten the first element into the second assembly.

9. The fastening device of claim 8, wherein the first element and the second assembly are both connectors.

10. The fastening device of claim 9, wherein the first assembly further comprises a flexible board and a metal sheet, one end of the flexible board is fixed, the metal sheet is fixed on a first surface of the other end of the flexible board and is positioned away from the second assembly, the first element is fixed on a second surface of the flexible board away from the metal sheet and faces to the second assembly, the adsorption unit adsorbs the metal sheet.

11. The fastening device of claim 10, wherein the metal sheet is a steel sheet.

12. The fastening device of claim 10, wherein the flexible board is made of a flexible material, when the adsorption unit adsorbs the metal sheet to drive the first assembly to move, the flexible board maintains a circular arc with a decreasing radius to achieve minimum stress, and the first assembly forms a fixed movement trajectory during the movement.

13. The fastening device of claim 8, further comprising a control unit, wherein the control unit is electrically connected to the location detection unit, the location detection unit records a location of the first assembly and sends a first location signal to the control unit, the location detection unit also records a location of the second assembly and sends a second location signal to the control unit, the control unit determines whether the first assembly is fastened into the second assembly by the first and second location signals.

14. The fastening device of claim 13, further comprising a driving unit, wherein the driving unit is electrically connected to the control unit and the adsorption unit, the driving unit is configured to drive the adsorption unit to adsorb the first assembly under a control of the control unit.

15. The fastening device of claim 14, wherein when the control unit determines that the first assembly is completely aligned with the second assembly according to the first location signal and the second location signal, the adsorption unit is driven to adsorb the first assembly, and the first assembly is fully fastened into the second assembly; and
when the control unit determines that the first assembly is not completely aligned with the second assembly according to the first location signal and the second location signal, the control unit controls the driving unit and the adsorption unit to push downward, the adsorption unit absorbs and discharges the first assembly at a high frequency to generate a disturbance, the disturbance causes the first assembly gradually slides into the second assembly.

16. The fastening device of claim 8, wherein the location detection unit is a camera.

17. The fastening device of claim 8, wherein the adsorption unit is a vacuum suction nozzle.

18. The fastening device of claim 14, wherein the control unit is a host and the driving unit is a robot.
